(19) United States
(12) Patent Application Publication
(10) Pub. No.: US 2003/0192035 A1
(43) Pub. Date: Oct. 9, 2003

(54) Systems and methods for implementing efficient execution transfers between successive translations of stack-based program code in a virtual machine environment

(76) Inventor: Evelyn Duesterwald ald, Somerville, MA (US)

Correspondence Address: HEWLETT-PACKARD COMPANY, Intellectual Property Administration, P.O. Box 272400, Fort Collins, CO, 80527-2400, US

(21) Appl. No.: 10/118,881

(22) Filed: Apr. 9, 2002

(51) Int. Cl. G06F 9/45; G06F 17/00; G06F 9/00

(52) U.S. Cl. 717/138; 717/148; 709/1; 709/328

(57) ABSTRACT

Systems and methods for implementing efficient execution transfers between successive translations of stack-based code in a virtual machine environment are provided. Briefly described, one such method comprises the steps of: defining a global translation convention for translating one or more stack-based code instructions on a register-based environment, the global translation convention specifying a predetermined portion of a stack-based context corresponding to a stack that is to be mapped to one or more registers corresponding to the register-based environment and enforcing the global translation convention for each translation of the one or more stack-based code instructions in the register-based environment.

### FIELD OF THE INVENTION

This disclosure generally relates to systems for translating stack-based program code in a virtual machine environment to be executed on a register-based hardware platform. More particularly, the disclosure relates to systems and methods for implementing efficient execution transfers between successive translations of stack-based code to register-based code in a virtual machine environment.

### BACKGROUND OF THE INVENTION

Currently, a variety of types of “virtual machines” are implemented in computing systems. In general, “virtual machine” is a term used to describe system software that functions as an interface between program code (e.g., Java® bytecode, etc.) and the hardware platform (e.g., microprocessor) that actually performs the instructions associated with the binary code.

A virtual machine converts each program instruction into a set of specific machine instructions that the hardware platform will understand. Most computer languages used to develop software applications require a separate compiler for each computer platform (i.e., for each computer operating system and the hardware set of instructions). Using a virtual machine, program code in a particular computer language may run on any platform provided the platform provides a virtual machine for the computer language.

Typically, virtual machines execute the binary code by either interpreting/emulating the binary code or translating the binary code. An interpreter/emulator refers to a program that executes instructions written in one language (e.g., C, C++, Fortran, LISP, Pascal, Prolog, Ada, Algol, Java, Bytecode, etc.). In general, there are two ways to run programs. As mentioned above, one way is to compile the program. The other way is to pass the program through an emulator/interpreter. An emulator/interpreter processes each instruction and performs the corresponding actions to implement it. In contrast, a compiler translates the instructions directly into machine language, which then can run natively on the underlying machine. Compiled programs generally run faster than interpreted/emulated programs. The advantage of an interpreter/emulator, however, is that it does not need to go through the compilation stage during which machine instructions are generated. This process may be time-consuming if the program is long. The interpreter/emulator, on the other hand, may immediately execute programs.

The classical approach for a virtual machine is to interpret/emulate the program code. However, a virtual machine may also translate the binary code. For example, rather than each instruction being interpreted/emulated one at a time, the code may be recompiled for a particular system platform by a just-in-time (JIT) compiler. In general, a JIT compiler is a program that translates the program code (which contains instructions that are otherwise interpreted/emulated) at run time into instructions that can be executed-directly by the hardware platform. For instance, in a program written in Java®, the source language statements are compiled by the Java® compiler into Java bytecode rather than into code that contains instructions that match a particular hardware platform. The bytecode is platform-independent code that may be sent to, and run on, any hardware platform that provides a virtual machine for it. The JIT compiler translates the bytecode by compiling the bytecode at run time into code adapted to be run on the hardware platform. Once the code has been compiled by the JIT compiler, it may run more quickly on the computer.

In such systems, the interpreted/emulated code instructions are often stack-based rather than register-based because stack-based code is more compact and platform independent. For example, in a stack-based environment, a data area or buffer (referred to as a stack, or operand stack) is used for storing requests that need to be processed. A stack is sometimes referred to as a push-down list because as new requests are received, they push down old ones. In other words, a program always takes the next item to process from the top of the stack.

FIG. 1 illustrates the contents of an exemplary stack at various points in time during operation of a stack-based program. The sample stack-based program comprises the following instructions (s0-s12):

| | |
|---|---|
| s0 = push 9 | s6 = add |
| s1 = push 9 | s7 = add |
| s2 = push 6 | s8 = print |
| s3 = push 4 | s9 = add |
| s4 = push 2 | s10 = add |
| s5 = push 1 | s12 = print |

A. Sample Stack-Based Program

As illustrated in FIG. 1, during operation of the stack-based program, instructions s0-s5 serve to “push,” or load, the corresponding values onto the stack. Each new value is added to the top of the stack. Instructions s6, s7, and s10 are “add” instructions. As further illustrated in FIG. 1, in order to implement an “add” instruction, the two operands from the top two positions in the stack are “popped” off the stack and added together, and the sum is “pushed” onto the top of the stack. For example, prior to instruction s6, the top two positions in the stack contain the values 1 (stack pointer five (SP5 )) and 2 (SP4). During instruction s6, the values in SP5 and SP4 are “popped” off the stack and added together. The value of the sum (1+2=3) is “pushed” onto the top of the stack at SP4.

Although virtual machine code is typically stack-based, the hardware platform is typically register-based. For example, processors comprise a plurality of registers. A register is generally defined as one of a small set of data holding places that are part of a processor and that provide a place for passing data from one instruction to the next sequential instruction or to another program to which, for example, the operating system has given control. A register must be large enough to hold a data value.

FIG. 2 illustrates a typical computing system 200 for implementing a virtual machine environment 204 that functions as an interface between stack-based program code 202 (e.g., Java® bytecode, etc.) and a register-based hardware platform 210. Virtual machine environment 204 often comprises a stack-based emulation system 206 and a register-based translation system 208. As described above, virtual machines may perform the program code (e.g., stack-based code 202) by either interpreting/emulating the program code or translating the code. Stack-based emulation system 206 may be configured to interpret/emulate stack-based program code 202.

During operation of such computing systems (e.g., computing system 200), certain portions of stack-based program code 202 may be emulated/interpreted via stack-based emulation system 206 and other portions may be translated to register-based code to directly execute on the underlying register based hardware platform (210). As illustrated in FIG. 2, before executing the translated stack-based program code 202, an entry context switch is performed during which the operand stack and other local context is mapped into machine registers associated with register-based translations for the hardware platform 210. Furthermore, when exiting from the translation and returning control back to stack-based emulation system 206, the state mapped in the registers is mapped back to the operand stack and the local context.

As illustrated in FIGS. 3 and 4, in existing virtual machines for translating and executing stack-based program code 202 on register-based hardware platform 210, an entry context switch and an exit context switch are performed before and after executing each translation. As shown in the example of FIG. 4, assume that instructions s7 and s8 from the example of FIG. 1 are to be translated by register-based translation system 208. Prior to executing the translation, the operand stack contains five values (e.g., SP0=9, SP1=9, SP2=6, SP3=4, and SP4=3). During the entry context switch, the entire contents of the operand stack and local context of the stack-based environment are mapped to machine registers in the register-based environment.

For example, the contents of each stack position (SP0-SP4) are loaded into machine registers. In addition, the stack-based instructions are translated into the appropriate register-based instructions. In this example, as described above, instruction s7 implements an “add” instruction, in which the two operands from the top two positions in the stack (SP4, SP3) are “popped” off the stack and added together, and the sum is “pushed” back onto the top of the stack. In the register-based environment, this instruction may be implemented as follows: r1=r2+r1. In other words, the contents of machine register (r1), which contains the operand in the top stack position, may be added to the contents of the machine register (r2), which contains the operand in the (top-1) stack position; and the result may be inserted in machine register (r1). After the translated instruction is executed, control is to be returned to stack-based emulation system 206. Therefore, during the exit context switch, the state mapped in the registers is mapped back to the operand stack and the local context by, for example, pushing the values from the appropriate machine registers (r5, r4, r3, r1) into the operand stack.

Existing methods of translating stack-based program code in a virtual machine to be performed on a register-based hardware platform may be inefficient. For example, consider the situation in which a second translation immediately follows the first translation. In these situations, the exit context switch from the first translation is followed by an entry context switch for the second translation. Therefore, a large amount of redundant context switching may be performed, which may reduce the overall efficiency of the translation solution. Furthermore, the code granularity provided by existing methods of translating stack-based program code may be limiting. In certain computing systems, it may be advantageous to decrease the granularity of the code to translate (i.e., reduce the size of the code being provided to the translation system). The code granularity of existing methods, however, is limited to the procedural boundaries, or method boundaries, of the underlying program.

Thus, there is a need in the industry for systems and methods for implementing efficient execution transfers between successive translations of stack-based program code to register-based code in a virtual machine environment.

### SUMMARY

The present invention provides systems and methods for implementing efficient execution transfers between successive translations of stack-based program code in a virtual machine environment. One embodiment is a method for implementing efficient execution transfers between successive translations of stack-based code in a virtual machine environment. Briefly described, one such method comprises the steps of: defining a global translation convention for translating one or more stack-based code instructions to execute in a register-based environment, the global translation convention specifying a predetermined portion of a stack-based context corresponding to a stack that is to be mapped to one or more registers corresponding to the register-based environment and enforcing the global translation convention for each translation of the one or more stack-based code instructions in the register-based environment.

Another embodiment of the present invention is a system for translating and executing stack-based instructions in a register-based environment. Briefly described, one such system comprises: a predefined global translation rule, which is stored in memory and adapted to control the translation of one or more stack-based code instructions to be executed in a register-based environment, the predefined global translation rule specifying a predetermined portion of a stack-based context corresponding to an operand stack that is to be mapped to one or more registers corresponding to the register-based environment; logic configured to receive the one or more stack-based code instructions; and logic configured to perform a translation of the one or more stack-based code instructions according to the predefined global translation rule.

A further embodiment of the present invention is a computing system for implementing a virtual machine environment that functions as an interface between stack-based code and a register-based hardware platform. Briefly described, one such computing system comprises a register-based hardware platform, an emulation system, and a translation system. The emulation system comprises logic configured to receive stack-based code instructions, decode the stack-based instructions, and emulate the stack-based instructions on the register-based hardware platform. The translation system comprises: a predefined global translation rule, which is stored in an associated memory and adapted to control the translation of the stack-based instructions to be translated, the predefined global translation rule specifying a predetermined portion of a stack-based context corresponding to an operand stack that is to be mapped to one or more registers associated with the register-based hardware platform; logic configured to receive the one or more stack-based instructions to be translated; and logic configured to perform a translation of the one or more stack-based instructions that are received according to the predefined global translation rule.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates the contents of an exemplary operand stack during operation of a sample stack-based program.

FIG. 2 illustrates an example of an existing computing system for implementing a virtual machine environment that functions as an interface between stack-based code and a register-based hardware platform.

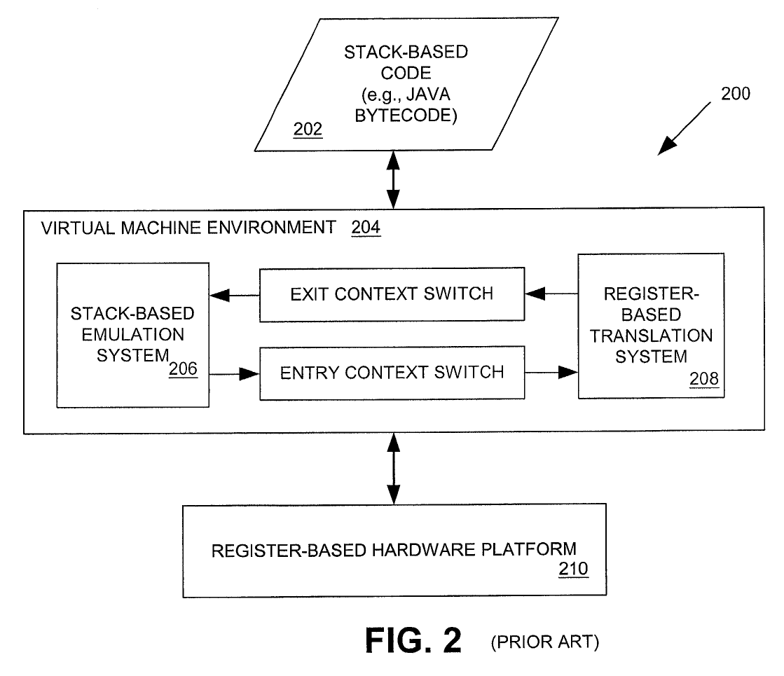

FIG. 3 illustrates the exemplary operand stack of FIG. 1, in which a portion of the stack-based program is being translated using an existing method for translating stack-based code.

FIG. 4 is a more detailed illustration of the entry and exit context switches of FIG. 3.

FIG. 5 is a block diagram of an embodiment of a computing system according to the present invention for implementing efficient execution transfers between successive translations of stack-based code in a virtual machine environment.

FIG. 6A is a first portion of a flow chart illustrating the architecture, operation, and/or functionality of the computing system of FIG. 5 according to the present invention.

FIG. 6B is a second portion of the flow chart of FIG. 6A.

FIG. 7 is a flow chart illustrating an embodiment of method according to the present invention for implementing efficient execution transfers between successive translations of stack-based code in a virtual machine environment.

FIG. 8 is a block diagram of another embodiment of a computing system according to the present invention for implementing efficient execution transfers between successive translations of stack-based code in a virtual machine environment.

FIG. 9 is a block diagram of an embodiment of a host computer system according to the present invention for implementing the systems of FIGS. 5 and 8.

### DETAILED DESCRIPTION

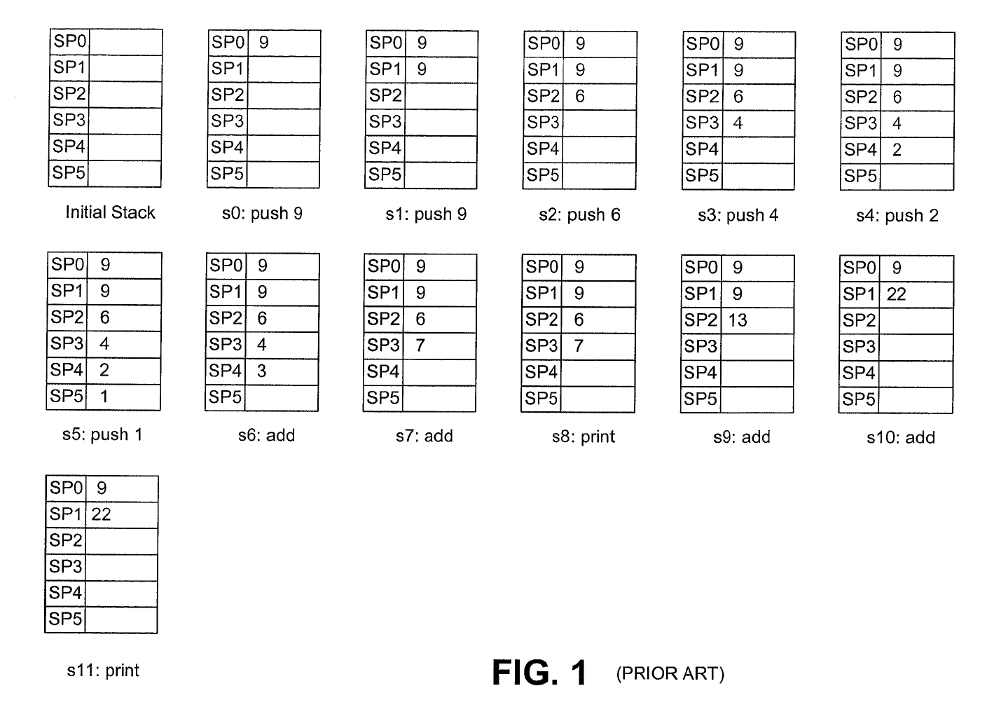

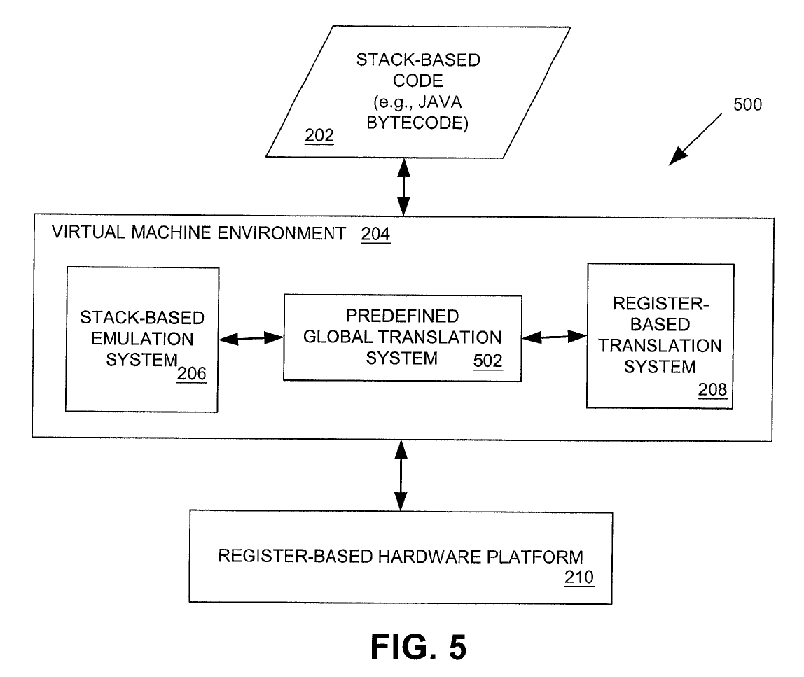

FIG. 5 illustrates one of many possible embodiments of a computing system 500 according to the present invention for implementing efficient execution transfers between successive translations of stack-based code in a virtual machine environment. As illustrated in FIG. 5, computing system 500 generally comprises a virtual machine environment 204 for providing an interface between stack-based code 202 and a register-based hardware platform 210. One of ordinary skill in the art will appreciate that stack-based code 202 may comprise any of a variety of types of compiled computer object code that is configured to be run in a virtual machine environment. In this regard, stack-based code 202 comprises one or more generalized stack-based machine instructions. Stack-based machine instructions are generally configured to be processed in a stack-based environment, such as the one described above with respect to FIGS. 1, 3, and 4. For instance, in a stack-based environment, a data area or buffer (referred to as a stack, or operand stack) is used for storing requests that need to be processed. A stack is sometimes referred to as a push-down list because as new requests are received, they push down old ones. In other words, a program always takes the next item to process from the top of the stack. The generalized stack-based machine instructions comprising stack-based code 202 are generally configured to perform functions, operations, etc. in the stack-based environment.

Accordingly, in one of many possible embodiments, stack-based code 202 comprises Java® bytecode and virtual machine environment 204 comprises a Java® virtual machine. Materials describing the operation, functionality, and/or architecture of the various Java® platforms (e.g., Java 2 Platform and predecessor Java® Development Kits (JDKs), etc.) may be found on the Sun Microsystems, Inc. web site at http://www.sun.com and on The Source for Java® Technology web site at http://java.sun.com/. All of these materials are hereby incorporated by reference in their entirety. Furthermore, one of ordinary skill in the art will appreciate that stack-based code 202 may comprise compiled stack-based instructions based on any of a variety of source code languages (e.g., C, C++, etc.).

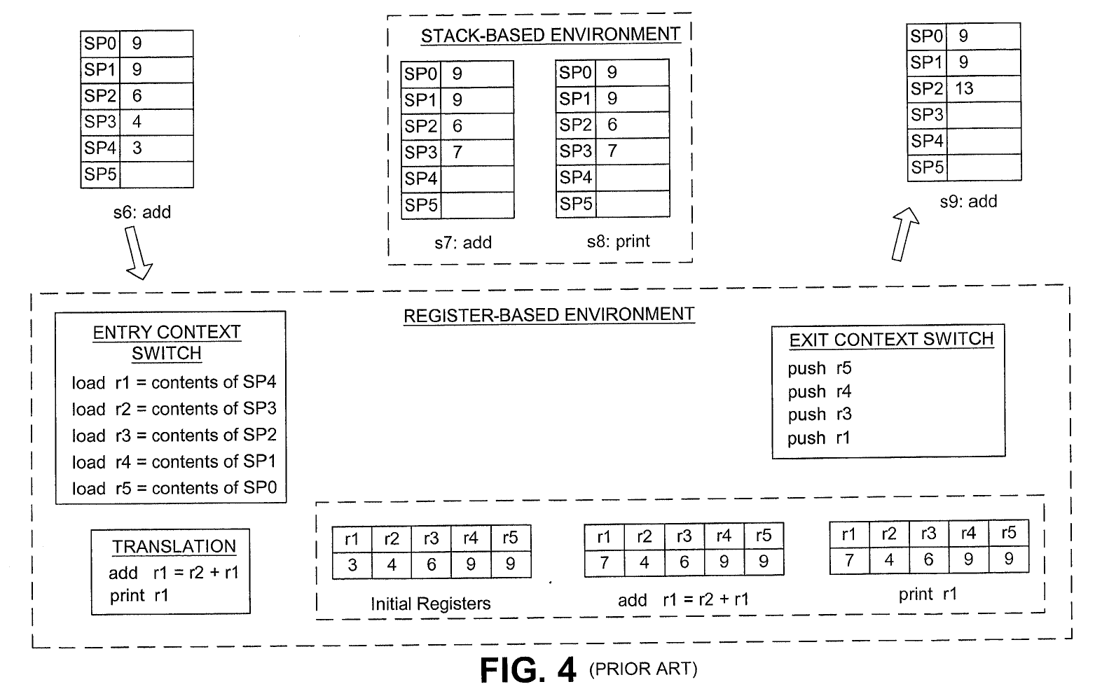

Referring again to FIG. 5, register-based hardware platform 210 may comprise any type of processing device that employs registers to perform processing functions. As stated above, registers are the data elements that provide a place for holding data operands and intermediate results between successively executed instructions. By way of example, in a register-based environment, instructions may be performed by loading values into registers and manipulating the contents of the registers. For instance, referring to the example of FIG. 4, register-based hardware platform 210 may perform a simple add instruction by loading the values of the two operands into two machine registers (r1, r2), adding the contents of r1 and r2, and loading the result back into r1.

Register-based hardware platform 210 may be provided by a custom-made or commercially-available processor, a central processing unit (CPU) or an auxiliary processor among several processors associated with computer system 500, a semiconductor based microprocessor (in the form of a microchip), or a macroprocessor, to name a few. It will be appreciated that the important aspect is that register-based hardware platform 210 employs a register-based approach for performing operations.

Referring again to FIG. 5, virtual machine environment 204 comprises system independent software (or in alternative embodiments, firmware, hardware, software, or any combination thereof) that functions as an interface between stack-based code 202 and register-based hardware platform 210. Virtual machine environment 204 may include a register-based translation system to convert each generalized stack-based machine instruction into a specific machine instruction that the hardware platform will understand. Most computer languages used to develop software applications require a separate compiler for each computer platform (i.e., for each computer operating system and the hardware set of instructions). Using a virtual machine, source language statements for a particular computer language may be compiled once and subsequently run on any hardware platform, as long as it is equipped with a virtual machine.

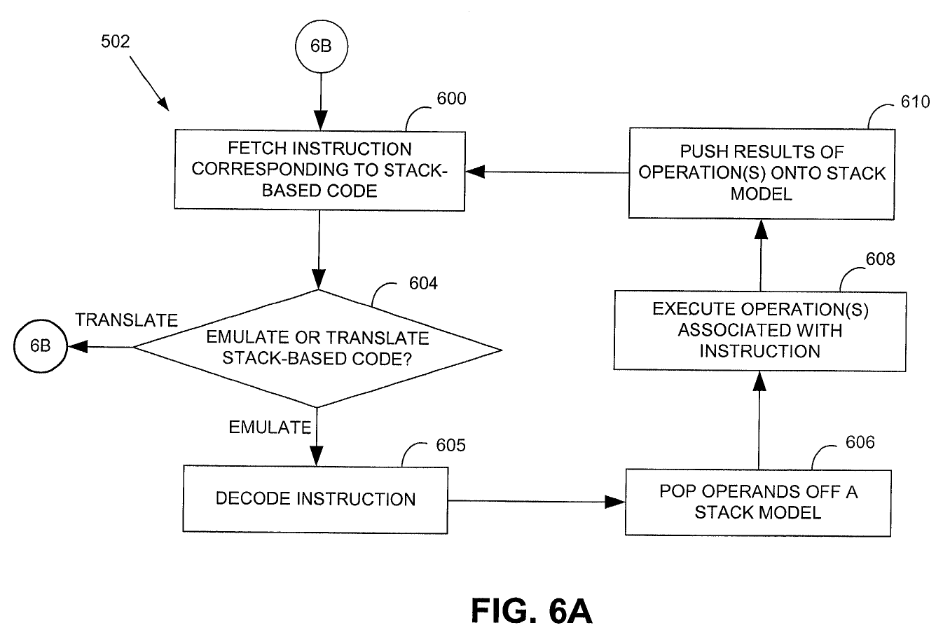

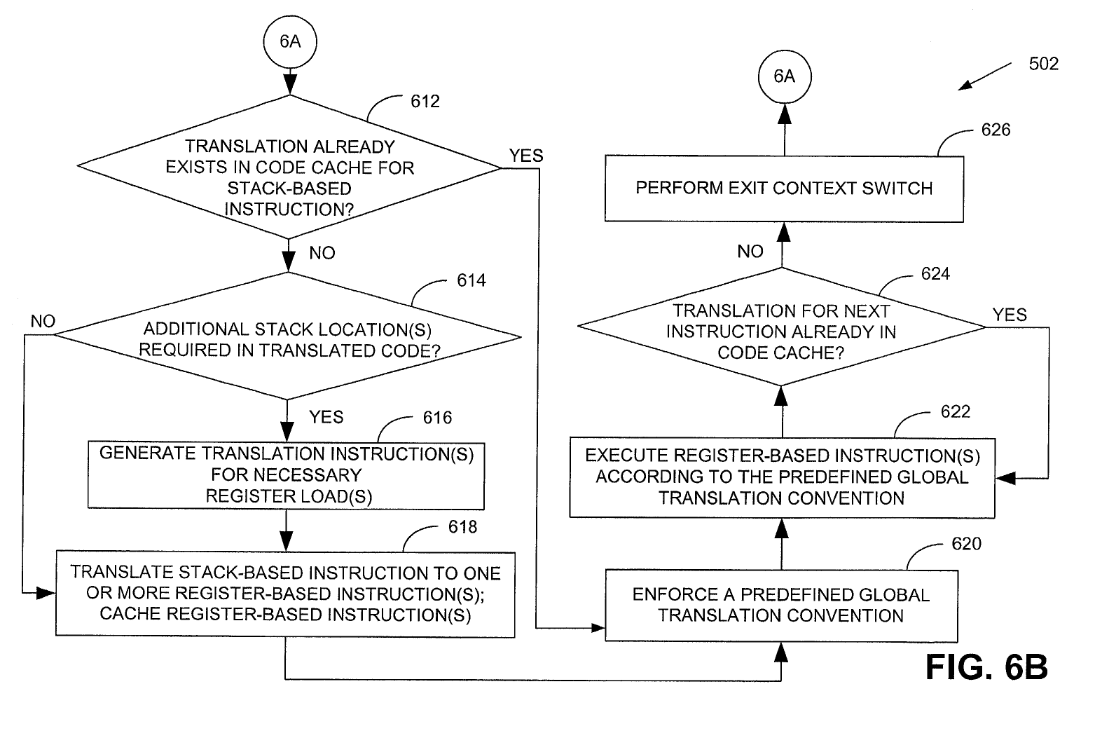

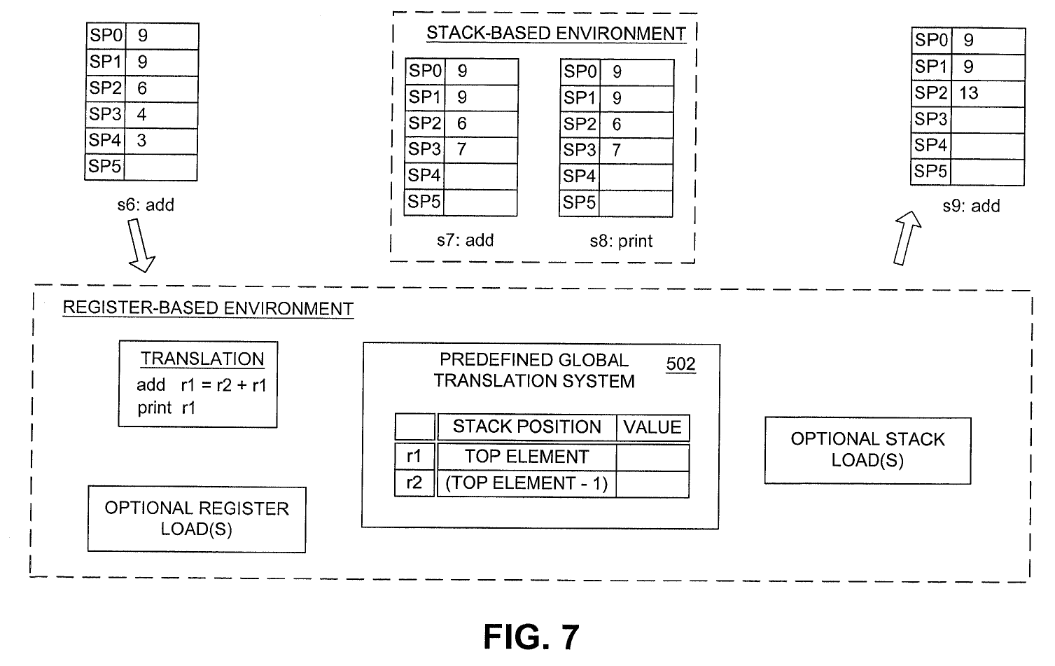

Virtual machine environment 204 comprises a stack-based emulation system 206, a register-based translation system 208, and a predefined global translation system 502 according to the present invention. The architecture, operation, and/or functionality of predefined global translation system 502 will be described in more detail below with respect to FIGS. 6 and 7. Nonetheless, as an introductory matter, the general architecture, operation, and/or functionality will be described briefly.

As described above briefly, virtual machine environment 204 performs the stack-based machine instructions associated with stack-based code 202 in two main ways: (1) interpreting/emulating the code via stack-based emulation system 206; and (2) translating the code via register-based translation system 208. Accordingly, during operation of virtual machine environment 204, control must be passed between stack-based emulation system 206 and register-based translation system 208. In existing systems and methods, before translating stack-based code 202, an entry context switch is performed, during which the operand stack and other local context is mapped into machine registers associated with register-based hardware platform 210. Furthermore, when exiting from the translation and returning control back to stack-based emulation system 206, the state mapped in the registers is mapped back to the operand stack and the local context.

Unlike existing systems and methods (which employ complete entry and exit context switching schemes between the register-based environment and the stack-based environment), the present invention only employs a partial entry and exit context switching schemes. The present invention provides, for example, predefined global translation system 502 as an interface between stack-based emulation system 206 and register-based translation system 208. In general, predefined global translation system 502 provides a global translation convention or rule for performing translations of instruction(s) corresponding to stack-based code 202. Instead of performing an entire entry and exit context switch for each translation (as in existing systems and methods), the global translation convention may specify that only a predetermined portion of a stack-based context corresponding to a stack is to be mapped to one or more registers corresponding to register-based hardware platform 210. For example, the global translation convention may establish a global rule that defines, for each translation, how much of the emulator/interpreter context is to be mapped into a specific register set. In other words, one specific embodiment of the global translation convention may specify that, upon exit and entry of a translation, the top two stack locations in the stack-based environment are to be mapped to two machine registers (r1, r2). Other local variables associated with the stack-based environment may be mapped into other registers. Furthermore, the global translation convention may be enforced both on entry and exit of each translation. In this manner, the global translation convention may eliminate redundant context switching between translations and thereby provide a method for implementing efficient execution transfers between successive translations of stack-based code 202.

Stack-based emulation system 206 comprises the logic (e.g., hardware, software, firmware, or any combination thereof) for interpreting/emulating stack-based bytecode 202. An interpreter/emulator refers to logic that emulates machine instructions written in a computer language (e.g., Java®, C, C++, Fortran, LISP, Pascal, Prolog, Ada, Algol, etc.). Accordingly, from the perspective of a program executed by computing system 500, stack-based emulation system 206 performs the actions that register-based platform 210 would perform. One of ordinary skill in the art will appreciate that stack-based emulation system 206 may be configured in a variety of ways. Stack-based emulation system 206 may be configured to receive stack-based code 202, interpret the code by determining the underlying semantics associated with the code, and carry out the semantic actions. Accordingly, stack-based emulation system 206 may comprise a system description associated with register-based hardware platform 210, which comprises the information about the corresponding instruction set that is needed to properly emulate register-based hardware platform 210.

Register-based translation system 208 comprises the logic (e.g., hardware, software, firmware, or any combination thereof) for translating stack-based code 202, rather than emulating/interpreting stack-based code 202. One of ordinary skill in the art will appreciate that the translation functionality may be implemented in a variety of ways. For example, in certain embodiments, a just-in-time (JIT) compiler may be employed. Using a JIT compiler, rather than each instruction being interpreted/emulated one at a time, stack-based code 202 may be compiled to register-based machine code. In general, a JIT compiler is a program that translates the code (which contains instructions that are otherwise interpreted/emulated) into instructions that can execute directly on the hardware platform. For instance, in a program written in Java®, the source language statements are compiled by the Java® compiler into bytecode rather than into code that contains instructions that match a particular hardware platform. The bytecode is platform-independent code that can execute in a virtual machine, but typically not directly on a particular hardware platform. The JIT compiler translates the bytecode by compiling the bytecode into code adapted to be run on the hardware platform. Once the code has been compiled by the JIT compiler, it may run more quickly on the computer.

FIGS. 6A and 6 B illustrate the architecture, operation, and/or functionality of an embodiment of predefined global translation system 502 according to the present invention. As mentioned above, predefined global translation system 502 provides a global translation convention or rule for performing translations of instruction(s) corresponding to stack-based code 202. Instead of performing an entire entry and exit context switch for each translation, the global translation convention may specify a predetermined portion of a stack-based context corresponding to a stack that is to be mapped to one or more registers corresponding to register-based hardware platform 210.

Referring again to FIG. 6A, at block 600, predefined global translation system 502 may fetch one or more instructions associated with stack-based code 202. It will be appreciated that, in certain computing systems, it may be advantageous to decrease the granularity of the code being translated (i.e., reduce the size of the code being provided to register-based translation system 208). Therefore, the size of the fetched code, the number of instructions, etc. may be varied depending on the particular system and/or application(s) being implemented.

At decision block 604, predefined global translation system 502 may determine whether the one or more fetched instructions are to be emulated via stack-based emulation system 206 or translated via register-based translation system 208. One of ordinary skill in the art will appreciate that the decision may be based on a variety of factors. For example, the decision may be based on whether the code is “hot,” (i.e., whether it is frequently executing). Predefined global translation system 502 may keep track of how frequently particular instructions are fetched at block 600. When the frequency of a particular instruction exceeds a predefined threshold, predefined global translation system 502 may decide to translate the instruction. If predefined global translation system 502 determines that the one or more instructions are to be emulated, control may be given to stack-based emulation system 206 (blocks 605, 606, 608, and 610). At block 605, predefined global translation system 502 decodes the instructions. After the instructions have been emulated, control may be returned to predefined global translation system 502 at block 600.

Referring to FIG. 6B, if it is determined that the one or more instructions are to be translated, at block 612, predefined global translation system 502 may determine whether a translation already exists in an associated code cache for the one or more instructions. As described in more detail below, the process of identifying which translated code is cached, as well as the caching process, may be implemented with a dynamic execution layer interface (DELI) that resides between register-based hardware platform 210 and virtual machine environment 204.

If a translation does exist in the code cache, at blocks 620 and 622, a predefined global translation convention is enforced and the translated instructions are executed. In the event that a translation does not already exist, predefined global translation system 502 may give control to register-based translation system 208. At decision block 614, predefined global translation system 502 determines whether additional stack location(s) are required in the translated code besides the registers that are guaranteed to be loaded by the global translation convention. As stated above, the predefined global translation convention provides a limit for how much of the stack-based environment is to be mapped into the register-based environment for each translation. Therefore, one of ordinary skill in the art will appreciate that there may be situations in which more of the stack-based context needs to be mapped to the register-based environment (e.g., additional stack positions need to be loaded into additional registers in order to perform the register-based instructions, additional local variables need to be loaded into registers, etc.).

If additional stack location(s) are required in the translated code, at block 616, translation instruction(s) for the necessary register load(s) are generated. At block 618, register-based translation system 208 translates the stack-based instruction to one or more register-based instructions according to the global translation convention. Thus, the translation is produced based on the assumption that the convention is enforced on the entry to the translations and the necessary instructions are generated to ensure that the convention is still enforced upon exit of the translation. The translation may then be stored in, for example, a code cache as described above. In this manner, the cached translation may be subsequently executed from the code cache (block 622).

As illustrated by block 620, the predefined global translation convention is enforced prior to executing a translation which is the case because, as stated above, the translations are based on the assumption that the convention is enforced when the translation is entered. Instead of performing an entire entry and exit context switch for each translation (as in existing systems and methods), the global translation convention may specify a predetermined portion of a stack-based context corresponding to a stack that is to be mapped to one or more registers corresponding to register-based hardware platform 210. For example, the global translation convention may establish a global rule that defines, for each translation, how much of the emulator/interpreter context is to be mapped into a specific register set. In other words, one specific embodiment of the global translation convention may specify that, upon exit and entry of a translation, the top two stack locations in the stack-based environment are to be mapped to two machine registers (r1, r2). Other local variables associated with the stack-based environment may be mapped into other registers. Furthermore, it should be noted that a partial context switch to enforce the predefined global translation convention may be enforced when first entering a translation (from block 612 or 618) or when exiting from the last subsequently executed translation (box 626). However, no additional context switching is needed when transferring control from one translation to another. In this manner, the predefined global translation convention may eliminate redundant context switching between translations and thereby provide a method for implementing efficient execution transfers between successive translations of stack-based code 202.

After the translation is produced at block 618, the register-based instructions are executed at block 622. At decision block 624, predefined global translation system 502 determines whether a previous translation exists in the code cache for the next instruction (blocks 616, 616, and 618). If the next instruction has been previously translated, a translation may exist in code cache (block 618). In this manner, successive translations may be executed very efficiently because another translation and additional context switching are not required in order to execute the next instruction (blocks 616 and 618). Rather, the predefined global translation convention ensures that register-based environment contains the proper stack-based context. However, in the event that a translation does not exist in code cache for the next instruction, flow continues to block 600.

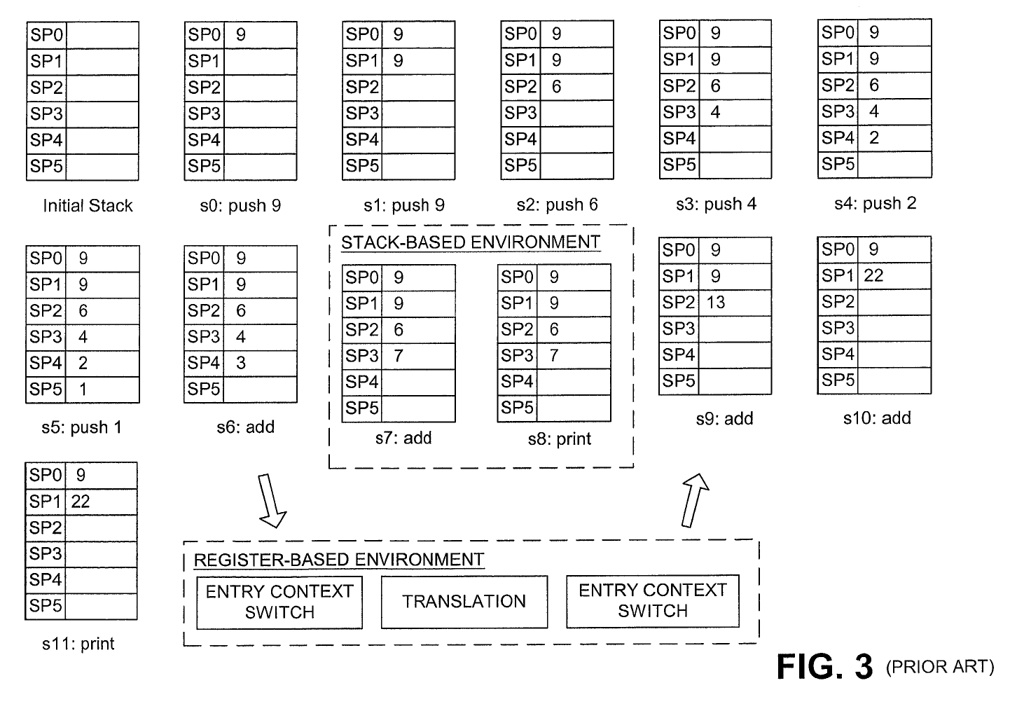

Referring to FIG. 7, various examples will be discussed in order to clarify this concept. FIG. 7 illustrates the exemplary stack of FIGS. 3 and 4 during operation of the sample stack-based program referenced above. In the example of FIG. 7, stack-based instructions s7 and s8 are being translated via register-based translation system 208. As illustrated in FIG. 7, predefined global translation system 502 may comprise the predefined global translation convention, which may be stored in memory or otherwise known by predefined global translation system 502. One of ordinary skill in the art will appreciate that the predefined global translation convention may be represented in a variety of ways. However, for purposes of clarity, in the embodiment illustrated in FIG. 7, the predefined global translation convention is represented as a data table, which specifies the number of stack positions being loaded into particular registers. In this example, the predefined global translation convention specifies that, for each translation, only the top two stack positions are to be loaded into registers.

As further illustrated in FIG. 7 and described above with respect to block 618, predefined global translation system 502 may translate stack-based instructions s7 and s8 to the following register-based instructions:

add r1=r2+r1 print r1

In order to produce these register-based instructions, only two the top two stack positions (SP4, SP3) need to be loaded into registers. Therefore, in this example, additional register loads would not be required. However, in situations where additional stack positions are needed to produce the register-based instructions, predefined global translation system 502 may determine that additional register loads are required.

For example, if the predefined global translation convention specified that only the top stack position (SP4) was to be loaded into a register (not the top two stack positions), predefined global translation system 502 would determine that an additional register load was required to produce the register-based add instruction. Referring again to FIG. 6B, in this instance, at block 616, predefined global translation system 502 would generate instructions as part of the translation to load the next stack position (SP3) into another register (r2) in order to perform the register-based add instruction, which requires two values.

If additional register loads are not required, at block 618, the register-based instructions are produced according to the predefined global translation convention. At block 622, the register-based instructions are executed. In the example of FIG. 7, after the register-based instructions are executed, r1 contains the sum of 3 (from SP4) and 4 (from SP3). Therefore, if the next instruction is not to be executed from code cache, predefined global translation system 502 initiates a complete context switch to load all currently valid stack locations prior to returning control to stack-based emulation system 206. In the example of FIG. 7, predefined global translation system 502 may push the value of r1 to the top of the stack. Referring again to FIG. 6B, after performing an exit context switch at block 626, the process may continue at block 600.

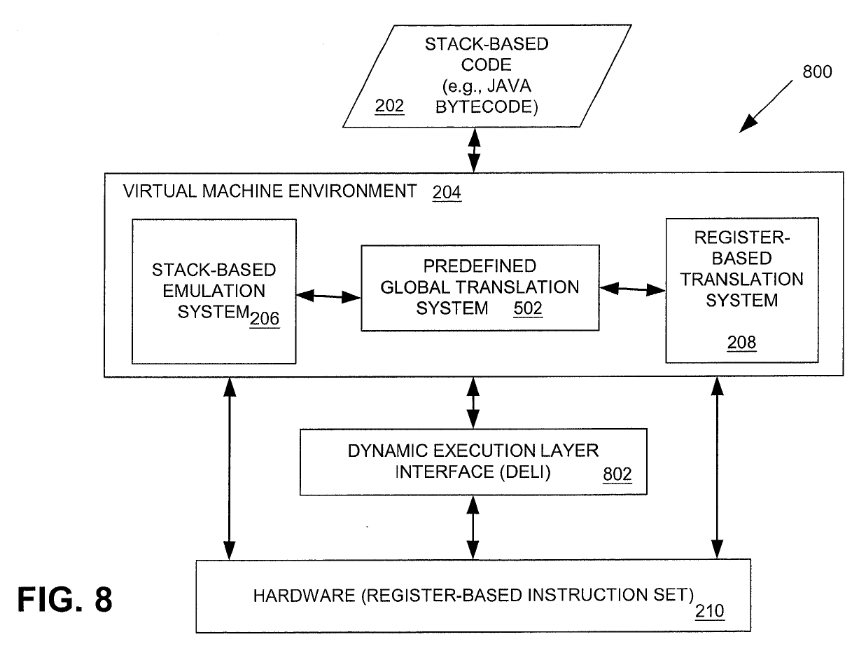

Referring to FIG. 8, virtual machine environment 204 may be implemented with a dynamic execution layer interface 802 as described below. FIG. 8 illustrates a computing system 800 according to the present invention in which the virtual machine environment 204 and predefined global translation system 502 are implemented with a dynamic execution layer interface 802.

Generally speaking, DELI 802 comprises a generic software layer written in a high or low level language that resides between applications (i. e., virtual machine environment 204), either below or above an operating system (O/S), and hardware to untie application binary code from the hardware. Through this arrangement, DELI 802 may provide dynamic computer program code transformation, caching, and linking services that can be used in a wide variety of different applications such as emulation, dynamic translation and optimization, transparent remote code execution, remapping of computer system functionality for virtualized hardware environments program, code decompression, code decrypting, etc. DELI 802 may provide its services while operating in a transparent mode, a nontransparent mode, or combinations of the two. In the transparent mode, DELI 802 automatically takes control of an executing program in a manner in which the executing program is unaware that it is not executing directly on computer hardware. In the nontransparent mode, DELI 802 exports its services through an application program interface (API) to the application (client), thereby enabling the application to control how DELI 802 reacts to certain system events. The various ways in which virtual machine environment 204 and DELI 802 may interface are described in U.S. patent application Ser. No. 09/924,260, filed Aug. 8, 2001, and entitled “Dynamic Execution Layer Interface for Explicitly or Transparently Executing Application or System Binaries,” which is hereby incorporated by reference in its entirety.

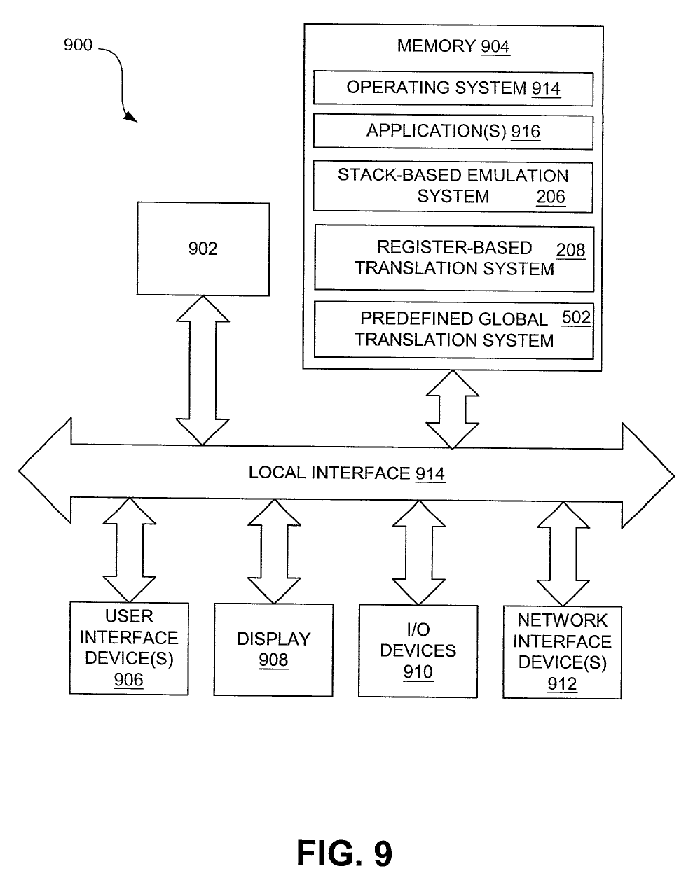

FIG. 9 is a block diagram illustrating an example host computer system 900 on which virtual machine environment 204 (including stack-based emulation system 206, predefined global translation system 502, and register-based translation system 208) may be executed. Generally speaking, the computer system 900 can comprise any one of a wide variety of wired and/or wireless computing devices, such as a desktop computer, portable computer, dedicated server computer, multi-processor computing device, cellular telephone, personal digital assistant (PDA), handheld or pen-based computer, and so forth. Irrespective of its specific arrangement, the computer system 900 can, for instance, comprise a processing device 902, memory 904, one or more user interface devices 906, a display 908, one or more input/output (I/O) devices 910, and one or more networking devices 912, each of which is connected to a local interface 914.

The processing device 902 can include any custom made or commercially available processor, a central processing unit (CPU) or an auxiliary processor among several processors associated with the computer system 900, a semiconductor based microprocessor (in the form of a microchip), a macroprocessor, one or more application-specific integrated circuits (ASICs), a plurality of suitably configured digital logic gates, and other well known electrical configurations comprising discrete elements both individually and in various combinations to coordinate the overall operation of the computing system.

The memory 904 can include any one of a combination of volatile memory elements (e.g., random access memory (RAM, such as DRAM, SRAM, etc.)) and nonvolatile memory elements (e.g., ROM, hard drive, tape, CDROM, etc.). The memory 904 typically comprises an operating system 914, one or more applications 916, stack-based emulation system 206, predefined global translation system 502, and register-based translation system 208 as described above. One of ordinary skill in the art will appreciate that the memory 904 can, and typically will, comprise other components which have been omitted for purposes of brevity.

The one or more user interface devices 906 comprise those components with which the user can interact with the computing system 900. For example, where the computing system 900 comprises a personal computer (PC), these components can comprise a keyboard and mouse. Where the computing system 900 comprises a handheld device (e.g., PDA, mobile telephone), these components can comprise function keys or buttons, a touch-sensitive screen, a stylus, etc. The display 908 can comprise a computer monitor or plasma screen for a PC or a liquid crystal display (LCD) for a handheld device.

With further reference to FIG. 9, the one or more I/O devices 91 0 are adapted to facilitate connection of the computing system 900 to another system and/or device and may therefore include one or more serial, parallel, small computer system interface (SCSI), universal serial bus (USB), IEEE 1394 (e.g., Firewire™), and/or personal area network (PAN) components. The network interface devices 912 comprise the various components used to transmit and/or receive data over a network. By way of example, the network interface devices 912 include a device that can communicate both inputs and outputs, for instance, a modulator/demodulator (e.g., modem), wireless (e.g., radio frequency (RF)) transceiver, a telephonic interface, a bridge, a router, network card, etc.

Various software and/or firmware has been described herein. It is to be understood that this software and/or firmware can be stored on any computer-readable medium for use by or in connection with any computer-related system or method. In the context of this document, a computer-readable medium denotes an electronic, magnetic, optical, or other physical device or means that can contain or store a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

While particular embodiments of the invention have been disclosed in detail in the foregoing description and drawings for purposes of example, it will be understood by those skilled in the art that variations and modifications thereof can be made without departing from the scope of the invention as set forth in the following claims.

1. A method for implementing efficient execution transfers between successive translations of stack-based program code in a virtual machine environment, the method comprising the steps of:
defining a global translation convention for translating one or more stack-based code instructions to execute in a register-based environment, the global translation convention specifying a predetermined portion of a stack-based context corresponding to a stack that is to be mapped to one or more registers corresponding to the register-based environment; and
enforcing the global translation convention for each translation of the one or more stack-based code instructions in the register-based environment.

2. The method of claim 1, wherein the step of enforcing the global translation convention comprises the step of enforcing the global translation convention prior to, and after, executing each translation.

3. The method of claim 1, wherein the stack-based code comprises Java bytecode.

4. The method of claim 1, wherein the predetermined portion of a stack-based context comprises a predetermined number of upper stack positions in the operand stack.

5. The method of claim 1, wherein the predetermined portion of a stack-based context is based on a statistical determination of an average code size corresponding to the one or more stack-based code instructions to be translated in the register-based environment.

6. The method of claim 1, further comprising the steps of:
receiving the one or more stack-based code instructions; and
performing a translation of the one or more stack-based code instructions according to the global translation convention.

7. The method of claim 1, further comprising the steps of:
receiving the one or more stack-based code instructions;
generating a translation of the one or more stack-based code instructions to be performed in the register-based environment; and
executing the translation of the one or more stack-based code instructions in the register-based environment according to the global translation convention.

8. The method of claim 1, further comprising the step of storing the translation of the one or more stack-based code instructions in a code cache.

9. The method of claim 8, wherein the step of storing the translation of the one or more stack-based code instructions comprises emitting the translation into a dynamic execution layer interface.

10. The method of claim 4, further comprising the steps of:
receiving the one or more stack-based code instructions;
determining that one or more additional upper stack positions in the operand stack are to be loaded into one or more additional registers in order to perform a translation of one or more stack-based code instructions in the register-based environment;
generating the translation of the one or more stack-based code instructions by loading the one or more additional upper stack positions in the one or more additional registers; and
executing the translation of the one or more stack-based code instructions according to the global translation convention.

11. The method of claim 8, further comprising the step of executing the translation of the one or more stack-based code instructions from the code cache.

12. A system for translating and executing stack-based instructions in a register-based environment, the system comprising:
a predefined global translation rule, which is stored in memory and adapted to control the translation of one or more stack-based code instructions to be executed in a register-based environment, the predefined global translation rule specifying a predetermined portion of a stack-based context corresponding to an operand stack that is to be mapped to one or more registers corresponding to the register-based environment;
logic configured to receive the one or more stack-based code instructions; and
logic configured to perform a translation of the one or more stack-based instructions according to the predefined global translation rule.

13. The system of claim 10, wherein the logic configured to perform a translation comprises:
logic configured to translate the one or more stack-based code instructions into one or more register-based instructions; and
logic configured to execute the one or more register-based instructions in the register-based environment by enforcing the predefined global translation rule.

14. The system of claim 13, further comprising logic configured to store the one or more register-based instructions in a code cache.

15. The system of claim 14, further comprising a dynamic execution later interface configured to provide the caching services.

16. The system of claim 12, wherein the predetermined portion of a stack-based context comprises a predetermined number of upper stack positions in the operand stack.

17. The system of claim 14, further comprising logic configured to execute the one or more register-based instructions from the code cache.

18. The system of claim 16, further comprising:
logic configured to receive the one or more stack-based code instructions;
logic configured to determine that one or more additional upper stack positions in the stack are to be loaded into one or more additional registers in order to perform a register-based translation of the one or more stack-based code instructions;
logic configured to generate a register-based translation of the one or more stack-based code instructions by loading the one or more of the additional upper stack positions in the one or more additional registers; and
logic configured to execute the register-based translation of the one or more stack-based code instruction by enforcing the predefined global translation rule.

19. The system of claim 12, wherein the one or more stack-based code instructions comprise Java bytecode.

20. The system of claim 12, wherein the predetermined portion of the stack-based context is based on a statistical determination of an average code size corresponding to the one or more stack-based code instructions to be translated in the register-based environment.

21. The system of claim 12, wherein the logic is software and further comprising a processing device configured to implement the software.

22. A computing system for implementing a virtual machine environment that functions as an interface between stack-based code and a register-based hardware platform, the computing system comprising:
a register-based hardware platform;
an emulation system comprising logic configured to receive stack-based instructions, decode the stack-based instructions, and emulate the stack-based instructions on the register-based hardware platform; and
a translation system comprising:
a predefined global translation rule, which is stored in an associated memory and adapted to control the translation of the stack-based instructions to be translated, the predefined global translation rule specifying a predetermined portion of a stack-based context corresponding to an operand stack that is to be mapped to one or more registers associated with the register-based hardware platform;
logic configured to receive the one or more stack-based instructions to be translated; and
logic configured to perform a translation of the one or more stack-based instructions that are received according to the predefined global translation rule.

23. The computing system of claim 22, wherein the logic configured to perform a translation comprises:
logic configured to translate the one or more stack-based instructions into one or more register-based instructions; and
logic configured to execute the one or more register-based instructions on the register-based hardware platform by enforcing the predefined global translation rule.

24. The computing system of claim 23, further comprising logic configured to store the one or more register-based instructions in a code cache.

25. The computing system of claim 24, further comprising a dynamic execution layer interface configured to provide the caching services.

26. The computing system of claim 22, wherein the predetermined portion of a stack-based context comprises a predetermined number of upper stack positions in the operand stack.

27. The computing system of claim 22, wherein the one or more stack-based code instructions comprise Java bytecode.

28. The computing system of claim 22, wherein the predetermined portion of the stack-based context is based on a statistical determination of an average code size corresponding to the one or more stack-based code instructions to be translated in the register-based environment.

29. The computing system of claim 22, wherein the logic is software and further comprising a processing device configured to implement the software.

30. The computing system of claim 24, further comprising logic configured to execute the one or more register-based instructions from the code cache.

31. The computing system of claim 22, wherein the predefined global translation rule specifies that prior to and after the translation of the one or more stack-based code instructions the predetermined number of upper stack positions in the operand stack are to be mapped between the one or more registers.
